(19) United States
(12) Patent Application Publication
(10) Pub. No.: US 2014/0122023 A1
(43) Pub. Date: May 1, 2014

(54) INTELLIGENT SYSTEMS, METHODS, AND COMPUTER READABLE MEDIA FOR MANAGING INTEGRITY OF A FIELD ASSET

(71) Applicant: Infosys Limited, Bangalore (IN)

(72) Inventors: Sandeep Kumar Dewangan, Bangalore (IN); Preeti Pisupati, Bangalore (IN)

(73) Assignee: Infosys Limited, Bangalore (IN)

(21) Appl. No.: 14/065,387

(22) Filed: Oct. 28, 2013

(30) Foreign Application Priority Data
Oct. 26, 2012 (IN) 4462/CHE/2012

(51) Int. Cl. G06F 11/00

(52) U.S. Cl. CPC G06F 11/008
USPC 702/182

(57) ABSTRACT

The present invention provides a method and system for managing integrity of a field asset. A request for managing the integrity of the field asset is received by a handheld device. A set of integrity data essential for resolution of the request is captured by the handheld device. One or more workflows, cross referenced from one or more existing engineering processes, are executed and a set of fitness for service evaluations are performed on the captured set of integrity data, during the execution of the one or more workflows. A report of the received request is created, when the one or more workflows are executed completely.

### RELATED APPLICATION DATA

This application claims priority to India Patent Application No. 4462/CHE/2012, filed Oct. 26, 2012, the disclosure of which is hereby incorporated by reference in its entirety.

### FIELD OF THE INVENTION

The present invention relates generally to a method and system of asset integrity management. More specifically, the present invention relates to a method and system for automated integrity management of field assets.

### BACKGROUND

Integrity management of engineering assets such as Oil and Gas pipelines, aircrafts and power plants necessitate extensive field activities including inspection, maintenance, monitoring, survey and repair activities, at regular intervals of time. Additionally, relevant asset integrity related regulations are enforced by regulatory authorities, on an engineering asset owner, in order to ensure maintenance of integrity of the engineering assets, as per accepted industry standards and practices. Such asset integrity related regulations, require the engineering asset owner to capture data related to the inspection, maintenance, monitoring, survey and repair of the engineering assets throughout an annual year, thereby leading to an accumulation of such data in geographically distributed storage devices. Secondly, while carrying out the field activities, inspection, maintenance and repair related standards, codes, procedures and practices need to followed, thereby requiring a field inspector, to perform a manual cross reference with such standards, codes, procedures and practices. Such manual cross referencing lack result repeatability, when performed by the field inspector at another time or when performed by a second field inspector. Thirdly, such manual cross referencing can also lead to high turn-around-time for the field inspector to complete the field activities, thereby leading to a revenue loss to the asset owner. Fourthly, such manual cross referencing, requires the field inspector to carry the inspection, maintenance and repair related standards, codes, procedures and practices in paper form while carrying out the field activities. Existing technologies require the field inspector to travel back and forth for receiving a field activity order and submitting the field activity report, thereby increasing the turnaround time for completing the field activity order.

Hence, there is a need for an alternative method and system that can provide an automated digital cross referencing to the standards, codes, procedures and practices thereby eliminates the need for the manual cross referencing by the field inspector. The alternative method and system must provide automatic engineering calculations and automatic workflow processes, in order to make decision making and the result independent the field inspector conducting the field activities. Further, the system must eliminate the necessity for the field inspector to carry the heavy inspection, maintenance and repair related standards, codes, procedures and practices in paper form. Additionally, the system must also reduce the turnaround time of completing the field activity order by the field inspector, by providing an automated synchronization and alert mechanism of the field activities with a centralized server and database. Thus a method for centralized asset integrity management and automated digital cross referencing and synchronization of field activities is proposed.

### SUMMARY

The present invention provides a method and system for managing integrity of a field asset. In accordance with a disclosed embodiment, the method may include receiving, by a handheld device, a request for managing the integrity of the field asset. A set of integrity data of the field asset essential for resolution of the request, is captured by the handheld device. One or more workflows, cross-referenced from one or more existing engineering processes, are executed and a set of fitness-for-service evaluations are performed on the captured set of integrity data, during the execution of the one or more workflows. A report of the received request is created, when the one or more workflows are executed completely.

In an additional embodiment, a system for managing integrity of a field asset is disclosed. The system comprises an input module of a handheld device, the input module configured to receive a request for managing the integrity of the field asset over a first communication link. A receptor module of the handheld device is configured to capture a set of integrity data of the field asset, where the set of integrity data is essential for resolving the received request. A workflow module is configured to execute one or more workflows while cross referencing the one or more workflows from one or more existing engineering standards. A calculation module is configured to perform a set of fitness-for-service evaluations on the captured set of integrity data, during execution of the one or more workflows. The workflow module is further configured to create a report of the received request, from one or more execution results that may be obtained on execution of the one or more workflows.

These and other features, aspects, and advantages of the present invention will be better understood with reference to the following description and claims.

### BRIEF DESCRIPTION OF THE DRAWINGS

FIG. 1 shows an exemplary system for managing integrity of a field asset.

FIG. 2 shows an exemplary system in which a preferred embodiment of managing integrity of a field asset is practiced.

FIG. 3 is a flowchart illustrating an embodiment of a method of managing integrity of a field asset.

FIG. 4 is a flowchart illustrating a preferred embodiment of a method of managing integrity of a field asset.

FIG. 5 is a flowchart illustrating a preferred embodiment of a method of managing integrity of a field asset.

FIG. 6 illustrates a generalized example of a computing environment 600.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

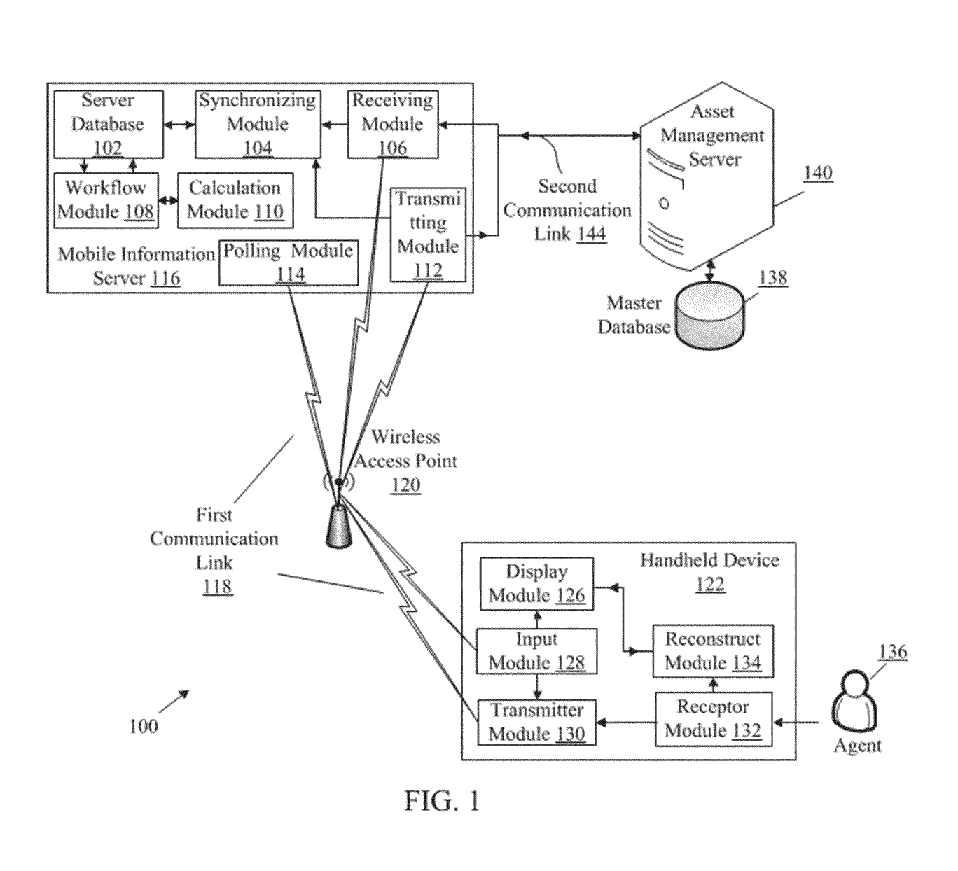

Disclosed embodiments provide computer-implemented methods, systems, and computer-program products for managing integrity of a field asset. FIG. 1 illustrates an exemplary system 100 in which various embodiments of the invention can be practiced. The exemplary system 100 includes an asset management server 140, a mobile information server 116, and a handheld device 122, associated with an agent 136 who may be entrusted with managing the integrity of the field asset. The mobile information server 116, further includes a server database 102, a synchronizing module 104, a receiving module 106, a workflow module 108, a calculation module 110, a polling module 114 and a transmitting module 112. The handheld device 122, includes a display module 126, an input module 128, a transmitter module 130, a display module 126, a reconstruct module 134, and a receptor module 132.

In an embodiment the asset management server 140, can be configured to create a request for managing the integrity of the field asset, and allocate the request to an agent 136. In the disclosed embodiment, the request can include an inspection, maintenance, monitoring, survey or repair of the field asset. The agent 136 is preferably, a field inspector, associated with the handheld device 122, and the handheld device 122, can be configured to receive the request via the mobile information server 116. The polling module 114, can be configured to poll the handheld device 122, for a connection session with the handheld device 122 over a first communication link 118. In the embodiment, the first communication link 118 can be an existing wireless technology accessible over a wireless access point 120. In an event the connection session is established with the handheld device 122, the receiving module 106, can fetch the request from the asset management server 140, over a second communication link 144. In the embodiment, instances of the second communication link 144, can include an internet link, an Ethernet bus and the like. The transmitting module 112, further transmits the received request to the handheld device 122. The input module 128, at the handheld device 122, can receive the request over the first communication link 118.

Based on the request, a set of integrity data essential for resolution of the request may be captured by the receptor module 134. In an instance, the set of integrity data may be manually inputted by the agent 136. In another instance, the set of integrity data may be acquired by a data acquisition device, or a sensor attached to the field asset, and subsequently fed to the receptor module 134. The set of integrity data can include an inspection data, a maintenance related data, a monitored data, a survey or repair related data of the field asset. One or more of the captured set of integrity data can be taken as an input on a displayed image of a nominal three dimensional model of the field asset on the display module 126 and be used for reconstructing the nominal three dimensional model, as per the captured set of integrity data by the reconstruct module 134. The set of integrity data can be transmitted by the transmitter module 130 of the handheld device 122 to the mobile information server 116. On receiving the set of captured set of integrity data by the receiving module 106 of the mobile information server 116, the mobile information server 116 can be configured to operate the workflow module 108 and the calculation module 110. One or more workflows as essential for resolution of the request can be executed by the workflow module 108. The one or more workflows is usually cross-referenced from one or more engineering processes, standards, codes and procedures. Instances of the one or more engineering processes, codes, standards and procedures. For execution of the one or more workflows, a set of fitness for service evaluations may need to be performed. A plurality of calculation libraries stored in the calculation module 110, may be invoked from the workflow module 108, for performing the set of fitness for service evaluations. In the disclosed embodiment, the workflow module 108 may include a plurality of application interfaces, where each application interface can invoke one or more of the application interfaces or one or more of the calculation libraries as required for execution of a workflow. During the execution of the one or more workflows, one or more execution results may be generated which can be transmitted to the handheld device 122, by the transmitting module 112. The one or more execution results can be received by the input module 128 of the handheld device 122, and displayed to the user on the display module 126 of the handheld device 122. On completing the execution of the one or more workflows, a report of the request may be created by the workflow module 108. The report can be transmitted to the handheld device and displayed on the display module 126. The report can include a plurality of elements such as a session log, the set of integrity data as captured by the receptor module 132, a set of calculated values that may be calculated during the execution of the one or more workflows, a location reference of the field asset and a set of images of the field asset. The plurality of elements of the report may be stored in the server database 102 of the mobile information server 116. The synchronizing module 104 of the mobile information server 116, shall synchronize the server database 102 with a master database 138 of the asset management server 140. On synchronizing the asset management server 140 gets updated with the plurality of elements of the report.

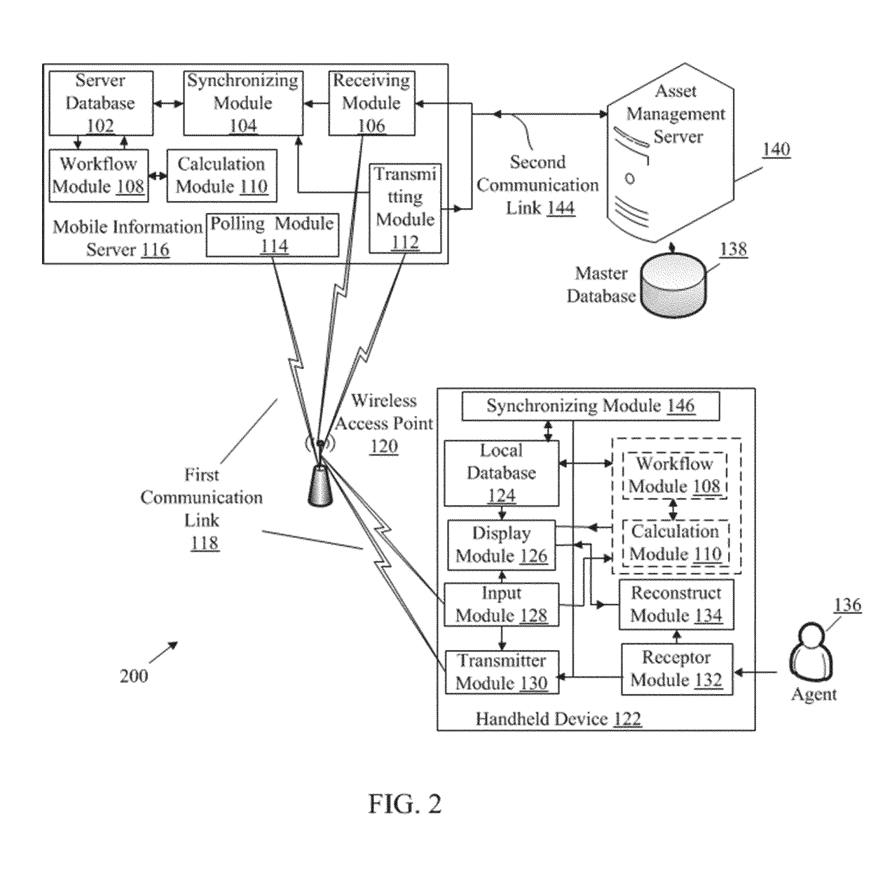

FIG. 2 illustrates an alternate exemplary system 200 in which various embodiments of the invention can be practiced. The alternate exemplary system 200, includes an asset management server 140, a master database 138, a mobile information server 116, and a handheld device 122 associated with an agent 136. The mobile information server 116 is in communication with the asset management server over a second communication link 144, and the mobile information server 116 is in communication with the handheld device 122 over a first communication link 118. The mobile information server includes a server database 102, a synchronizing module 104, a receiving module 106, a workflow module 108, a calculation module 110, a polling module 114, and a transmitting module 112. Further, the handheld device 122, includes an input module 128, a transmitter module 130, a display module 126, a local database 124, a reconstruct module 134, a receptor module 132, a workflow module 108 and a calculation module 110 and a synchronizing module 146.

The asset management server 140 can be configured to create a request for managing the integrity of the field asset, and allocate the request to an agent 136. In an embodiment, the request can include an inspection, maintenance, monitoring, survey or repair of the field asset. The agent 136 is preferably, a field inspector, associated with the handheld device 122, and the handheld device 122, is configured to receive the request via the mobile information server 116. The polling module 114, can be configured to poll the handheld device 122, for a connection session with the handheld device 122 over a first communication link 118. In the embodiment, the first communication link 118 can be an existing wireless technology accessible over a wireless access point 120. In an event the connection session is established with the handheld device 122, the receiving module 106, can fetch the request from the asset management server 140, over a second communication link 144. In the embodiment, instances of the second communication link 144, can include an internet link, an Ethernet bus and the like. The transmitting module 112, further transmits the received request to the handheld device 122. The input module 128, at the handheld device 122, can receive the request over the first communication link 118.

Based on the request, a set of integrity data essential for resolution of the request may be captured by the receptor module 134. In an instance, the set of integrity data may be manually inputted by the agent 136. In another instance, the set of integrity data may be acquired by a data acquisition device, or a sensor attached to the field asset, and subsequently fed to the receptor module 134. The set of integrity data can include an inspection data, a maintenance related data, a monitored data, a survey or repair related data of the field asset. One or more of the captured set of integrity data can be taken as an input on a displayed image of a nominal three dimensional model of the field asset on the display module 126 and be used for reconstructing the nominal three dimensional model, as per the captured set of integrity data by the reconstruct module 134. The reconstructed three dimensional model shall represent a real image of the field asset on which computations and further analysis may be carried out.

In the disclosed embodiment, on receiving the request, the handheld device 122 may download a set of application interfaces from the workflow module 108, and a set of associated calculation libraries from the calculation module 110, where the set of application interfaces and the set of calculation libraries may be essential for executing one or more workflows for the purpose of resolution of the request. The handheld device 122, can deploy the downloaded set of application interfaces and the set of calculation libraries, and hence execute the one or more workflows. The one or more workflows is usually cross-referenced from one or more engineering processes, standards, codes and procedures. Instances of the one or more engineering processes, codes, standards and procedures. For execution of the one or more workflows, a set of fitness for service evaluations may need to be performed. The fitness for service evaluations can be computed by the set of downloaded calculation libraries.

One or more execution results generated during the execution of the one or more workflows can be displayed on the display module 126. On completing the execution of the one or more workflows, a report can be created and stored in the local database 124. The report can include a plurality of elements such as a session log, the set of integrity data as captured by the receptor module 132, a set of calculated values that may be calculated during the execution of the one or more workflows, a location reference of the field asset and a set of images of the field asset. The plurality of elements of the report may be stored in the local database 124 of the handheld device 122. The transmitter module 130 can transmit the created report to the mobile information server 116, and the transmitting module 112 of the mobile information server 116 can transmit the created report to the Asset management server 140. The created report shall be stored in the master database 138 of the asset management server 140. Further, when the handheld device 122 establishes a connection session with the mobile information server 116, the synchronizing module 146 synchronizes the local database with the master database of the asset management server.

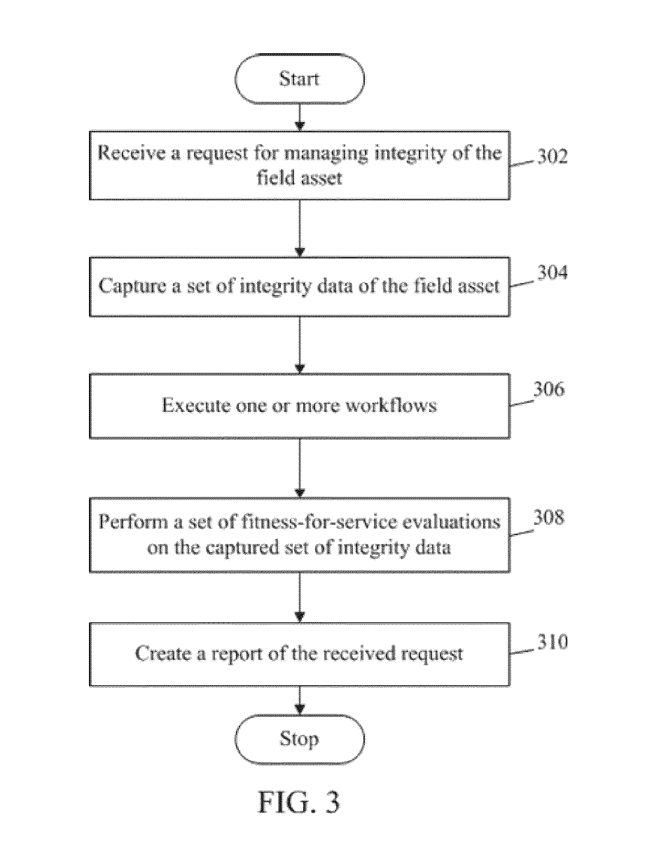

FIG. 3 is a flowchart that illustrates a method performed for managing integrity of a field asset in accordance with an embodiment of the present invention. A request for managing the integrity of the field asset is allocated by an asset management server to an agent such as a field inspector. At step 302, the request for managing the integrity of the field asset is received on a handheld device of the agent. Instances of the handheld device can include a cellphone, a mobile phone, a PDA, a laptop and any other electronic device capable of communication over a wireless communication medium. The request may be received by a sms, an email, and such other network transfer protocols. On receiving the request, at step 304, the handheld device may capture a set of integrity data of the field asset, for the purpose of resolution of the request. Further, at step 306, one or more workflows, can be executed and at step 308, a set of fitness-for-service evaluations may be computed on the captured set of integrity data during the execution of the one or more workflows. The one or more workflows shall be reference from standard engineering procedures, codes and processes. On completing the execution of the one or more workflows, a report of the received request can be generated at step 310. The report can include a session log of the request, the integrity of the field asset, a monitored set of integrity data, a set of calculated values of the integrity data, a set of observations made by the agent, a location reference of the field asset, a set of images of the field asset, and a summary of the completed request.

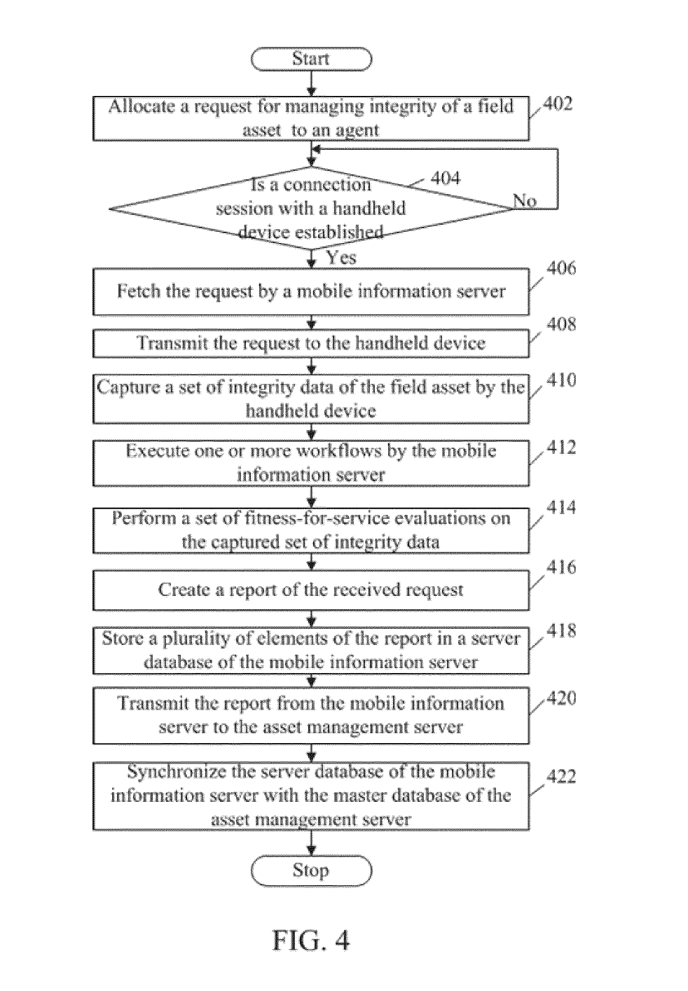

FIG. 4 illustrates an alternate embodiment of a method of practicing the instant invention. At step 402, a request for managing integrity of a field asset is allocated by an asset management server to an agent, such as a field inspector. At step 404, a mobile information server, continuously or intermittently polls a handheld device of the agent for a connection session. In an event a connection session is established with the handheld device of the agent, at step 406, the request is fetched by the mobile information server, from the asset management server. On fetching the request, at step 408, the request is transmitted by the mobile information server to the handheld device. On receiving the request, at step 410, a set of integrity data essential for resolution of the request is captured by the handheld device. In an instance, the set of integrity data can be acquired by a data acquisition device such as a sensor positioned on the field asset. In another instance, the set of integrity data may be observed by the agent and fed manually into the handheld device. In yet another instance, one or more of the captured set of integrity data may be inserted manually by the agent on a nominal three dimensional model of the field asset as displayed on the handheld device. On inserting values of the captured set of integrity data on the nominal three dimensional model, the nominal three dimensional model can be reconstructed on the handheld device based on the captured set of integrity data to display a true image of the field asset on the handheld device. The true image of the field asset can enhance the perceptiveness, judgment, and observation power of the field agent. The set of integrity data can be transmitted from the handheld device to the mobile information server over a first communication link. At step 412, one or more workflows can be executed at the mobile information server, where the received set of integrity data can be inputs to one or more steps of the one or more workflows. In an instance, the mobile information server can include a plurality of application interfaces where each application interface can invoke one or more application interfaces or one or more calculation libraries or both. The calculation libraries shall be configured to perform a set of fitness-for-service evaluations, at step 414, as required during the execution of the one or more workflows. On completing the execution of the one or more workflows, at step 416, a report can be created. A plurality of elements of the report can be stored in a server database of the mobile information server, at step 418. At step 420, the created report may be transmitted to the asset management server, where the report maybe further stored in the master database. It would be essential to synchronize the server database with the master database, at step 422, so that current integrity data of the field asset is reflected in the master database of the asset management server.

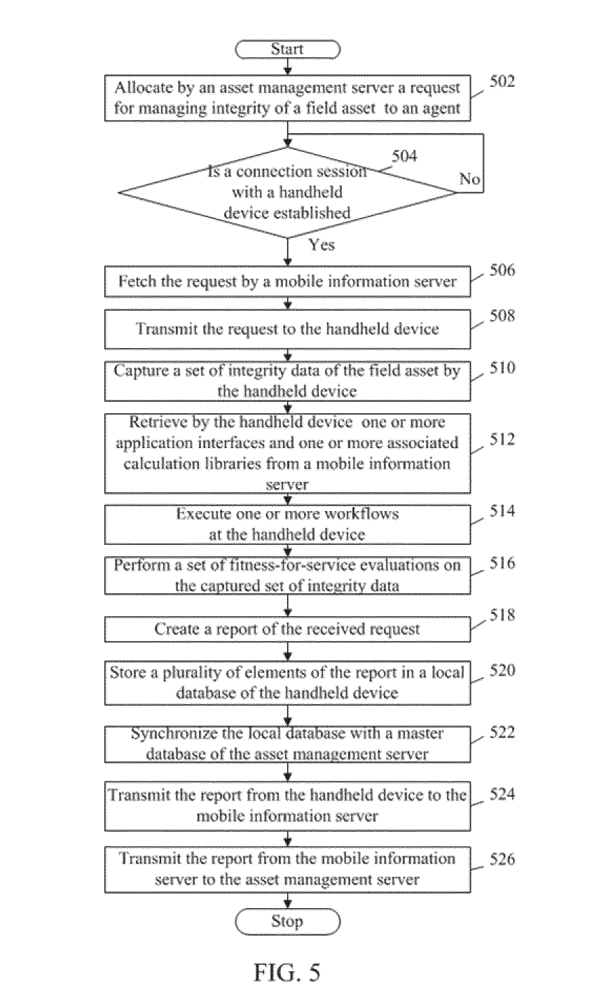

FIG. 5 illustrates a preferred embodiment of a method of practicing the instant invention. In the preferred embodiment, at step 502, a request for managing integrity of the field asset is allocated by an asset management server to an agent, where the agent is associated with a handheld device. At step 504, a mobile information server in communication with the asset management server, continuously polls the handheld device for a connection session over a first communication link. The first communication link can be any wireless technology such as cellular networks, WLAN and the like. In an event the connection session is established with the handheld device, the request is fetched by the mobile information server from the asset management server at 506. At step 508, the request can be transmitted to the handheld device for further processing. Based on the request, at step 510, a set of integrity data as essential for resolution of the request may be captured by the handheld device. In a scenario when the first communication link with the mobile information server is weak or the when the first communication link faces signal distortions or communication failures, a set of application interfaces and a set of calculation libraries, that maybe essential for execution of one or more workflows can be downloaded, at step 512, from the mobile information server into the handheld device. At step 514, the one or more workflows may be executed on the handheld device, and at step 516, a set of fitness-for-service evaluations as required during the execution of the one or more workflows may be computed by invoking the one or more downloaded calculation libraries at the handheld device. As a result, a report of the request can be generated at step 518, on the handheld device. At step 520, a plurality of elements of the report can be stored in a local database of the handheld device. At step 522, the local database can be synchronized with a master database of the asset management server, where current set of integrity data of the field asset and monitored data of the field asset can be updated into the master database. A process of synchronizing can take place only when the connection session is established between the mobile information server and the handheld held device. Further, at step 524, the created report may be transmitted to the mobile information server, and at step 526, the mobile information server may in turn forward the created report to the asset management server, where the report shall be stored in the master database.

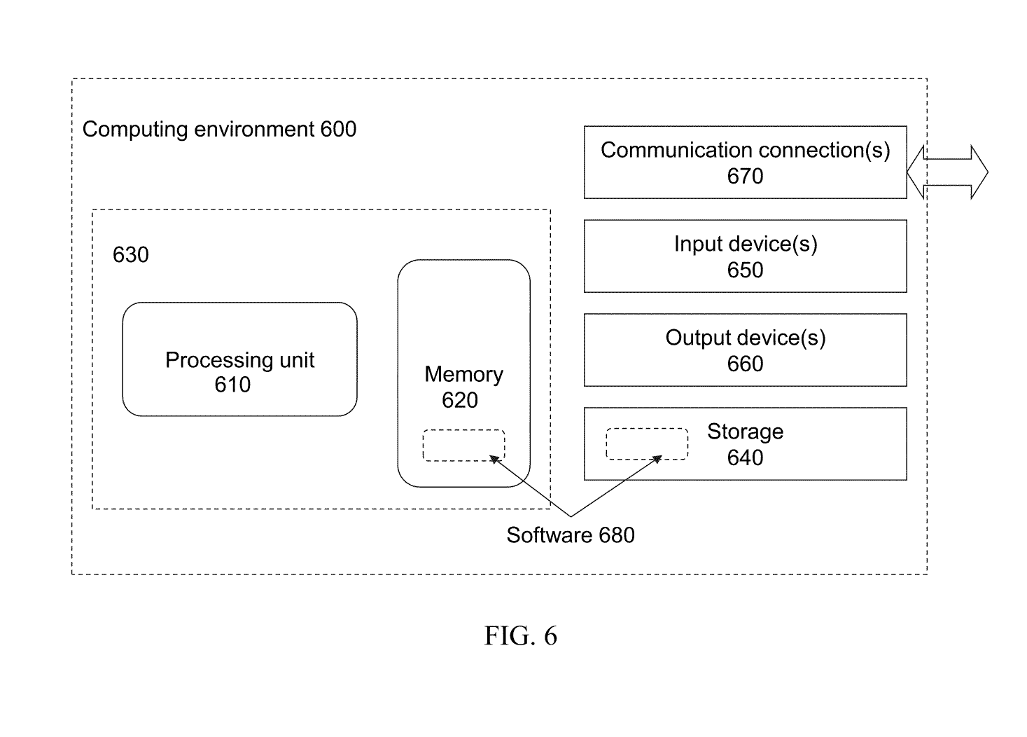

One or more of the above-described techniques can be implemented in or involves one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 640, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which can be used to store information and which can be accessed within the computing environment 600. In some embodiments, the storage 440 stores instructions for the software 680.

The input device(s) 650 may be a touch input device such as a keyboard, mouse, pen, trackball, touch screen, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 600, computer-readable media include memory 620, storage 640, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method of managing integrity of a field asset, the method comprising:
receiving, by a handheld device, a request for managing the integrity of the field asset;
capturing, by the handheld device, a set of integrity data of the field asset, whereby the set of integrity data is essential for resolution of the received request;
executing one or more workflows, whereby the one or more workflows is cross-referenced from one or more existing engineering processes;
performing a set of fitness-for-service evaluations on the captured set of integrity data, during the execution of the one or more workflows; and
creating a report of the received request, when the one or more workflows is executed.

2. The method of claim 2, wherein a mobile information server includes a plurality of application interfaces and a plurality of calculation libraries, whereby an application interface is configured to invoke one of one or more of the plurality of application interfaces, one or more of the plurality of calculation libraries and both, for processing the step of executing one or more workflows.

3. The method of claim 2, wherein each of the plurality of calculation libraries are configured to perform one or more of the set of fitness-for-service evaluations.

4. The method of claim 2, wherein a plurality of elements of the report are stored in a master database of an asset management server.

5. The method of claim 4, further comprising:
allocating, by the asset management server, the request to an agent, whereby the agent is associated with the handheld device;
polling, by the mobile information server, for a connection session with the handheld device;
fetching, by the mobile information server, the request from the asset management server, when the connection session with the handheld device is established; and
transmitting, by the mobile information server, the request to the handheld device.

6. The method of claim 4, further comprising:
retrieving, by the handheld device, one or more application interfaces of the plurality of application interfaces, and one or more associated calculation libraries of the plurality of calculation libraries, from the mobile information server, for processing the step of executing one or more workflows, and the step of performing a set of fitness for service evaluations;
performing, by the handheld device, the step of creating a report;
storing the plurality of elements of the report and the report in a local database of the handheld device;
transmitting, by the handheld device, the report to the mobile information server;
synchronizing the local database with the master database of the asset management server, when the handheld device establishes a connection session with the mobile information server; and
transmitting, by the mobile information server, the report to the asset management server.

7. The method of claim 4, further comprising:
performing, by the mobile information server, the step of executing one or more workflows, the step of performing a set of fitness for service evaluations and the step of creating a report;
providing, by the mobile information server, one or more execution results and the created report to the handheld device, whereby the one or more execution results are obtained during processing the step of executing one or more workflows;
storing, the plurality of elements of the report and the report in a server database of the mobile information server;
transmitting, by the mobile information server, the report to the asset management server; and
synchronizing the server database with the master database.

8. The method of claim 4, wherein the plurality of elements of the report comprise: a session log, the captured set of integrity data, a set of calculated values, a set of observations, a location reference of the field asset, and a set of images of the field asset.

9. The method of claim 1, further comprising:
inserting, by the handheld device, one or more of the captured set of integrity data on a nominal three dimensional model of the field asset, whereby the nominal three dimensional model of the field asset is displayed on a display module of the handheld device; and
reconstructing, by the handheld device, the nominal three dimensional model of the field asset, based on the captured set of integrity data.

10. The method of claim 1, wherein the request includes at least one of an inspection, a maintenance, a monitoring, a survey and a repair of the field asset.

11. The method of claim 1, wherein the set of integrity data includes one or more of a field asset inspection data, a field asset maintenance data, a monitored data, a surveyed data and a repair related data of the field asset.

12. A system for managing an integrity of a field asset, the system comprising:
a handheld device, the handheld device comprising:
an input module, configured to receive a request for managing the integrity of the field asset over a first communication link; and
a receptor module, configured to capture a set of integrity data of the field asset, whereby the set of integrity data is essential for resolution of the received request;
a workflow module, configured to:
execute one or more workflows, whereby the one or more workflows is cross-referenced from one or more existing engineering processes; and
create a report of the received request; and
a calculation module, configured to perform a set of fitness-for-service evaluations on the captured set of integrity data, during execution of the one or more workflows.

13. The method of claim 12, wherein the calculation module comprises a plurality of calculation libraries whereby each of the plurality of calculation libraries is configured to perform one or more of the set of fitness-for-service evaluations.

14. The system of claim 13, wherein the workflow module comprises a plurality of application interfaces, whereby an application interface is configured to invoke one or more of the plurality of application interfaces and one or more calculation libraries.

15. The system of claim 14, further comprising:
an asset management server, configured to create the request, and allocate the request to an agent, whereby the agent is associated with the handheld device;
a mobile information server, configured to host the workflow module and the calculation module; and
a master database of the asset management server, configured to store a plurality of elements of the created report.

16. The system of claim 15, wherein the mobile information server further comprises:
a polling module, configured to poll the handheld device, for establishing a connection session with the handheld device over the first communication link;
a receiving module, configured to fetch the request from the asset management server over a second communication link, when the connection session is established with the handheld device; and
a transmitting module, configured to transmit the request to the handheld device.

17. The system of claim 16, wherein the handheld device further comprises:
a display module configured to display the one or more execution results and the created report, whereby the one or more execution results are obtained on execution of the one or more workflows.

18. The system of claim 17, wherein the handheld device is further configured to:
download a set of application interfaces from the workflow module and a set of associated calculation libraries from the calculation module, whereby the set of application interfaces and the set of associated calculation libraries are essential for executing the one or more workflows; and
deploy the set of application interfaces and the set of associated calculation libraries for creating the one or more execution results and the report at the handheld device.

19. The system of claim 18, wherein the handheld device further comprises:
a transmitter module, configured to transmit the created report to the mobile information server;
a local database configured to store the plurality of elements of the report; and
a synchronizing module, configured to synchronize the local database with the master database of the asset management server, when the handheld device establishes a connection session with the mobile information server.

20. The system of claim 17, wherein:
a transmitter module of the handheld device, is configured to transmit the captured set of integrity data to the mobile information server; and
the mobile information server is further configured to operate the workflow module and the calculation module.

21. The system of claim 20, wherein the mobile information server further comprises:
a server database configured to store the plurality of elements of the report and the created report; and
a synchronizing module configured to synchronize the server database with the master database.

22. The system of claim 21, wherein the transmitting module of the mobile information server is further configured to:
transmit the created report to the asset management server and the handheld device, and
transmit the one or more execution results to the handheld device.

23. The method of claim 15, wherein the plurality of elements of the report comprise: a session log, the captured set of integrity data, a set of calculated values, a set of observations, a location reference of the field asset, and a set of images of the field asset.

24. The system of claim 17, wherein the receptor module, is further configured to accept one or more of the captured set of integrity data as inputs to a nominal three dimensional nominal model of the field asset, whereby the nominal three dimensional model of the field asset is displayed on the display module.

25. The system of claim 24, wherein the handheld device further comprises:
a reconstructing module, configured to reconstruct the nominal three dimensional model of the field asset, based on the accepted one or more captured set of integrity data.

26. The system of claim 12, wherein the request includes at least one of an inspection, a maintenance, a monitoring, a survey and a repair of the field asset.

27. The system of claim 12, wherein the set of integrity data includes one or more of a field asset inspection data, a field asset maintenance data, a monitored data, a surveyed data and a repair related data of the field asset.

28. A computer program product consisting of a plurality of program instructions stored on a non-transitory computer-readable medium that, when executed by a computing device, performs a method for managing integrity of a field asset, the method comprising:
receiving, by a handheld device, a request for managing the integrity of the field asset;
capturing, by the handheld device, a set of integrity data of the field asset, whereby the set of integrity data is essential for resolution of the received request;
executing one or more workflows, whereby the one or more workflows is cross-referenced from one or more existing engineering processes;
performing a set of fitness-for-service evaluations on the captured set of integrity data, during the execution of the one or more workflows; and
creating a report of the received request, when the one or more workflows is executed.
